(19) United States
(12) Patent Application Publication
(10) Pub. No.: US 2014/0274350 A1
(43) Pub. Date: Sep. 18, 2014

(54) PROGRESSIVE WAGERING SYSTEM

(71) Applicant: Richard A. Herbert, Riverside, IL (US)

(72) Inventor: Richard A. Herbert, Riverside, IL (US)

(21) Appl. No.: 14/216,195

(22) Filed: Mar. 17, 2014

Related U.S. Application Data
(60) Provisional application No. 61/793,410, filed on Mar. 15, 2013.
(60) Provisional application No. 61/835,969, filed on Jun. 17, 2013.

(51) Int. Cl. G07F 17/32

(52) U.S. Cl. CPC G07F 17/3258
USPC 463/27

(57) ABSTRACT

A progressive wagering system having at least one processor and a wagering base with information. Wagers are input from a plurality of terminals to create a first pool and to access the information in the wagering base. The at least one processor is programmed to: (a) identify wagers that have accessed information in the wagering base; and (b) identify a return for each input wager accessing the information in the wagering base. The plurality of terminals are configured to allow selective inputting of at least a part of an input wager to a second pool. The at least one processor is programmed to award a payout to a first player from the second pool based upon criteria related to the first player's activity related to the first pool.

### CROSS-REFERENCE TO RELATED APPLICATIONS

This application is a non-provisional of Application Nos. 61/793,410, filed Mar. 15, 2013 and 61/835,969, filed Jun. 17, 2013.

### BACKGROUND OF THE INVENTION

1. Field of the Invention

This invention relates to wagering systems and methods and more particularly to wagering systems and methods that utilize a progressive jackpot.

2. Background Art

The modern slot machine industry continues to enjoy an explosion of innovations with regards to animation, sound effects, and general entertainment improvements for their players. Yet a long standing staple of the industry has seen virtually no change. The basic underlying foundation of the industry, the gambling aspect, has seen very little evolution in the last few decades, or more. The progressive jackpot, specifically, remains the same today as it was three or more decades ago.

The progressive jackpot is, at its heart, a very low probability, high odds bet. For years the slot industry has simply set this type of bet as a very low probability event on a random number generator searching a universe of possible results that is available if the player lands on that low probability event result in the course of the player's regular play. Most times there is a requirement that a player wager at least a certain minimum amount to even be eligible to win the progressive jackpot.

At least two forms of Historical Racing now exist. RaceTech's Instant Racing (see U.S. Pat. Nos. 6,358,150 and 6,450,887) and Post Pari-mutuel Racing (PPM; see U.S. Pat. Nos. 5,888,136 and 6,152,822 (the Herbert Patents) incorporated herein by reference).

In the current state of the art, fixed odds slots' progressive jackpots are implemented via the use of a random number generator whereby in the course of regular play a very small probability within the universe of all the probabilities available to the random number generator can be accessed by the player. Certain minimum bet requirements are usually required by the game operator to allow the player access to this small probability. But this small probability lies within the whole game context. The game operator designates a very small portion of each player's total bet per pull to feed the progressive jackpot, which then increases in value until one player actually accesses the small winning probability in the course of regular play. Each individual play has exactly the same fixed small probability of accessing the progressive jackpot as each prior and each subsequent play does. If the probability of accessing the progressive jackpot was 0.0000001 (odds are 9,999,999 to one) on the first play, it would remain fixed as such for every single play until the progressive jackpot is won. The probability never changes and under current rules and regulations in jurisdictions allowing fixed odds slot play, it is prohibited from doing so.

### SUMMARY OF THE INVENTION

The invention herein is a unique departure from the methodology used by the slot machine industry to implement its progressive jackpot. It has no roots in any prior art used by the slot machine industry, nor in historical racing in contesting for progressive jackpots. The methodology is multi-faceted (three elements and a Community Play example of use) with a multitude of optional choices for the game operator to enhance entertainment value for the game player.

The current invention, initially described as applied to pari-mutuel historical racing, creates a new, unique methodology for playing progressive jackpots and features of the methodology allow for the game operator to enhance the entertainment and gambling attraction for players. A separate pool is set up to fund the progressive jackpot that is completely novel to the current state of the art regarding both fixed odds games and Historical Racing devices.

In one form, the invention is directed to a progressive wagering system having at least one processor and a wagering base having information. A plurality of terminals are provided at which wagers are input to create a first pool and to access the information in the wagering base. A probability value for accessing, through input wagers, information in the wagering base is different for different of the information that is in the wagering base. The at least one processor is programmed to: (a) identify wagers that have access information in the wagering base; and (b) identify a return for each input wager accessing the information in the wagering base. The plurality of terminals are configured to allow selective inputting of at least a part of an input wager to a second pool. The at least one processor is programmed to award a payout to a first player from the second pool based upon criteria related to the first player's activity related to the first pool.

### BRIEF DESCRIPTION OF THE DRAWINGS

FIG. 1 is a schematic representation of a progressive wagering system according to the invention.

### DETAILED DESCRIPTION OF THE PREFERRED EMBODIMENT

The description hereinbelow describes exemplary formats and utilizes many existing technologies to explain the inventive concepts. There is an infinite number of game formats and system variations that are contemplated and would be obvious to one skilled in the art without departing from the overall inventive concepts.

In an exemplary embodiment, the inventive methodology for progressive jackpots is illustrated utilizing what will be called herein “3 games in 1,” understanding many variations utilizing the same methodology can be created. The probability is partially undetermined to access the progressive jackpot. The probability to win the progressive jackpot may be made dependent (for each progressive jackpot offered) on a multitude of factors, some of which depend on the player's style and speed of play. How much the player chooses to wager per input and how fast the player plays may determine the overall probabilities of success in this methodology as the player is under time constraints. As well, fixed probabilities within a timed game offered may bear upon a player's chances to access the progressive jackpot within each timed game. This affords net variable probabilities of accessing any progressive jackpot that can only be calculated when the player's choices are considered. This will become clear when the methodology is detailed. Further, the issue of pari-mutuel payouts complicates calculations of determining a winning probability in relation to player reward.

The inventive method of funding the progressive jackpot is unique as it removes the funding method as described above for fixed odds slot machines and replaces it with a completely new method to fund the progressive jackpots. The progressive jackpots are funded by setting up (in the 3 games in 1 example) separate pools removed from the normal betting pools. The players deposit “qualifying” money wagers into these separate pools and those players that are successful in winning certain designated other bets in the normal betting pools share in the distribution of the qualifying funded separate pools. In any given pool there may be one winner, more than one, or no winners (as determined by pari-mutuel wagering rules within the Historical Racing game). In this exemplary embodiment, if there are no winners, 75% of the net pool from the game on hand (net pool equals gross pool for the game less commissions) carries over while 25% (25% of the net pool only from the current game being bet, not the carryover) is awarded to those players achieving the qualifying criteria to share in a consolation prize. Should no player qualify to share in the consolation prize, then 100% of the net pool shall carry over to the next race game which would be a replaying of the probabilities/odds of the race game just wagered on (but for which no one achieved the set criteria to win or win the consolation of the progressive jackpot). Note: a full winner or winners would receive the entire carryover jackpot in a pari-mutuel manner, should there be no consolation winners.

The arbitrarily designated Three Games In One format, which is a preferred embodiment will now be outlined to illustrate how the play would proceed, understanding that a limitless variety of different games could be conceived, but would follow the methodology of pool construction taught here.

As an example, being played as wagering pari-mutuelly on historical racing, several distinct pari-mutuel pools would be set up into which players wager over the course of a timed period of approximately 58 minutes. All Historical Racing methodologies wager in the pari-mutuel manner and a timed period of 58 minutes would define the wagering period for this example progressive jackpot. This progressive might begin at 8:00 pm, ending at 8:58 pm with the next progressive game then starting at 9:00 pm and ending at 9:58 pm.

In the example of Three Games In One, 50 pools exist:
Eight (8) Win Pools
Eight (8) Place Pools
Eight (8) Show Pools
Eight (8) Perfecta Pools
Eight (8) Trifecta Pools
Eight (8) Superfecta Pools
Two (2) Pick Four Pools.

Note: Any number or type of bet (pool) is usable as long as they are of sufficient number to accommodate this methodology and allow for adequate pari-mutuel pool liquidity.

Now the players are betting into these 50 pools in their ordinary pari-mutuel play during the progressive game wagering period, and the funds bet into these pools, in that ordinary play, are not involved at all in this methodology. That is a unique aspect of this invention—the distinct pari-mutuel pool, with its dedicated funding mechanism, and being won by meeting criteria in playing the regular offered bets from the general game 50 pari-mutuel pools.

The manner and methods of how the players bet into these exampled 50 pools in their ordinary play can be varied according to any and all the regular methods of betting, and of any type of Historical Racing game being used.

In all cases, a separate pool(s) is set up to fund the progressive jackpots. In this example, “Three Games In One”, the first of these is arbitrarily indentified as “The Grand Slam.” The regular play on the example fifty pools is used to demonstrate it. In Grand Slam play, a “play three ¢ progressive bet button” is available to be depressed, and then it would light up and stay lit until it would be pushed again. If left unlit no three ¢ sum is deducted from player credits and no winning results from the regular play of the 50 pools would then be qualified to count toward accumulating the criteria wins to satisfy the certain established criteria to win the Grand Slam progressive. If the three ¢ button remains lit, then a three ¢ sum is deducted from the player's credits along with the credits for the regular bets he/she executes. One cent each is deposited into each of the three progressive jackpots respectively called “Grand Slam,” “Superfectas” and “Pick Fours”, which make up the three games in one. These three ¢ bets then act to qualify any regular bets made on the 50 pools so that they then (if they win) are counted toward achieving the established criteria to win, or win the consolations of the progressive jackpots offered.

Any number of one, two, three, four, or more progressive games may be set up with varying criteria to win, but this example is illustrative of all. In one exemplary form of the Grand Slam, during the course of the 58 minute period a player must win one Win bet, one Place bet, one Show bet, one Perfecta bet, one Trifecta bet, one Superfecta bet, and one Pick Four bet to win the progressive jackpot. If they win any six of the seven bets they would qualify as a consolation winner. (We might allow the smaller betting player a fair chance of winning progressive jackpots, something current state of the art fixed odds slots do not do. In the embodiment, here exampled, the 6 winning bets for consolation as well as the 7 winning bets needed for a full jackpot would each qualify, regardless if the winning bet on the 50 pools regular game was a 1¢ winning Bet or a 12¢ winning Bet.) In this example, the size of each of the regular bets made into the regular pools is of no consequence; the player need merely win one of each type (a one cent win is as good as a twelve cent win). Should they win one of each type bet twice in the course of the game, they would have two winning tickets in the pari-mutuelly divided pool. If they hit one of each of the seven types once and then win all but one of the seven criteria again, in the same game, they would then also win a consolation progressive jackpot to go with their full win.

Note: Other arrangements regarding the amount of each bet (in the regular play) can be configured in for other embodiments, but in this embodiment, we qualify each winning bet into the regular pools regardless of its size (1¢/3¢/10¢) (another embodiment might otherwise weight the bet size of the win). Note also that the player's selection of total bet size in regular play coupled with his/her speed of play bears upon their probability of winning the progressive jackpot. This is because in order to win the progressive jackpot the criteria must be met within the 58 minute example time frame of the game. This does not happen with current fixed odds slots progressive jackpots where an exact probability of winning such progressive is known for each and every play. According to the invention, the probability is dependent on multiple factors and is not fully calculable at any point in time before such a jackpot is won. Should a player leave the 3¢ button off, then that regular bet play on that turn would not count toward meeting the progressive jackpot criteria but would, of course, count as wins or losses for regular 50 pool play. In other words while the results would count in regular 50 pool play, any wins achieved with the 3¢ button off, would not count toward achieving the necessary criteria to win these types of progressive jackpots.

Should a player then switch the 3¢ button back on during the remaining time period for the progressive, then all “on button” plays would once more qualify any regular 50 pool winning bets toward meeting the progressive criteria within the remaining 58 minute time span.

Note, that the 3¢ Button (Bet 3¢ Progressive), being on or off, has no bearing at all on the regular 50 pool play and the wins and losses of those bets over the course of regular 50 pool play. In a novel manner entertainment and excitement have been added to the progressive jackpot play in this type of wagering. A feedback device might be provided showing, in this example, for Grand Slam progressive play, seven small colored LED lights under the Grand Slam label on the machine console, one light each for Win, Place, Show, Perfecta, Trifecta, Superfecta and Pick Four. Each LED light would light as that specific type of bet is won and is qualified. If the player wins the Grand Slam and then is approaching a second cycle win, the video screen could notify the player they have one criterion to meet to achieve a second win (either a consolation or a complete jackpot second win). Similar LED lights would be in place for the other progressive bets of the three-in-one game. A winning “ticket” would qualify as a win and not both a win and a consolation (this is routine in both fixed odds gaming and pari-mutuel play).

The second progressive jackpot will be called, as one example, “Superfectas.” In this progressive jackpot, one cent of the 3¢ from the 3¢ button would be deposited into the Superfectas separate Progressive pool (as it was in the Grand Slam). Here, during the course of the 58 minute progressive period, a player must win “qualified” (3¢ button on) three different Superfectas of the eight offered or two different Superfectas to win the consolation (alternatively four different Superfectas and three to win the consolation). Again it is possible to have multiple pari-mutuel winners and one player again can have more than one winning ticket, or a winning ticket and a consolation ticket—and even two consolation tickets.

The third progressive jackpot would be, in the example here, the “Pick Fours.” As above, the 3¢ button would qualify a bet and here the objective would be to win both Pick Fours in the course of the 58 minute period. Winning one of the two Pick Fours would win the consolation. (Alternatively, there might be no consolation for winning one of the two. Other numbers and wins could be used.) Again, multiple winners for one player are possible and again a winning ticket qualifies only as a winner and not as both a winner and a consolation.

With such a progressive jackpot system set up, very large winning progressive jackpots would be readily available to be won by the players. As an example, say 600 people are on the pari-mutuelly connected system for 8 hours on a typical night and perhaps 800 machines in total were available. Assume 500 of 600 players that were actively playing opted to play the progressive 3 in 1 game. Assume they bet 8 bets per minute, regardless if they are a 30¢, 80¢ or $1.50 per play bettor. For the progressive jackpot here illustrated (3 in 1 game), they would contribute 24¢ per minute times 500 players equals $120 per minute times 480 minutes equals $57,670 divided into three pari-mutuel pools, or $19,200 each for the Grand Slam, Superfecta, and Pick Fours. Assume a Grand Slam will hit 12 times in the eight hours along with 36 consolations. Consolations might total approximately $133 per winner, while full jackpots might be $1200. Approximately 10% would be deducted for commissions so consolations would have a net prize of approximately $120 while full jackpots would be about $1080. Superfectas might yield in the same 8 hours approximately $360 consolations and full jackpots of $3240, while Pick Fours might yield $320 consolation and full jackpots of $8000 to $17,280. These are very attractive progressive jackpots to offer for 1¢ bets—all taking place in an eight hour period in one night with a limited number of players. With larger participation with networked machines within a state, jackpots four to five times these could be achieved.

In a second application of the first element of the invention it can be applied to, and enhance the play of, fixed odd slot machines. Because the odds are fixed and the wagering period is not constrained by the need to end the wagering period in a prescribed time in order to determine the final payout odds, the wagering period of the fixed odds slot machine is continuous. There is no need to calculate odds as the odds are unchanging and are fixed and are not a product of (derived from) the betting. Therefore, to construct progressive jackpots in the manner detailed above as applied to pari-mutuel historical racing, it is necessary to artificially set up time periods that can be called games. Then the various criteria to win a progressive jackpot or to win its consolation must take place within this artificially constructed time period. Now the operator can conduct the progressive jackpots just as described for pari-mutuel historical racing above. The operator of this modified fixed odds slot machine game now has two new options. He/she can pay the entire carryover to the first player to meet the winning criteria (At that point in time any players that are one criteria short of winning would have a consolation win. This is a hybrid where odds are fixed but progressive jackpots are paid pari-mutuelly just as described in the Historical Racing description.) and stop the game. Or the operator can let the full time period play out and then award any consolation winners, multiple full winners, or execute carryover procedures. In all other respects, the construction of the pools and the mechanics are as described above in the examples for Grand Slam, Superfectas, and Pick Fours in application to pari-mutuel Historical Racing. Separate pari-mutuel pools funded by the 3¢ button are set up and certainly the operator can name this game whatever he/she wishes and identify any variety of criteria wins in regular fixed odds game play needed to win a progressive jackpot. As in the Historical Racing explanation, consolations could be set at, perhaps, 25% of the net pool, while winners might be 75% (100% if there were no consolation winners). These progressive jackpots are unique, in that their pari-mutuel pools are funded solely via the dedicated (here, the 3¢ bet button) special funding bet, while the bet is won by achieving a set of criteria grounded in the play of the regular game and all confined inside a predetermined time period (here 58 minutes). A pure pari-mutuel creature results when done with Historical Racing and a hybrid when adapted to Fixed Odds Slots. The fixed odds people could decide to pay to the first winner but would, arguably, be best served by allowing the full time period (58 minutes) to play out, then rewarding all winners pari-mutuelly who met the betting criteria inside the time period.

An exemplary variation, added to the above embodiments, will be arbitrarily identified as “Sweep Three”. It is based on the play three games in one. Before a game begins, the video screen would ask the player if he/she wishes to play the 25¢ “Sweep Three.” If the player agrees he/she pushes a virtual 25¢ Button on the screen and 25 1¢ credits are pulled from his/her balance and deposited into another separate pari-mutuel pool. This one bet covers the player's entire outlay for a 58 minute game. The screen warns the player that if he/she does not plan on playing the “Play 3 Progressives” in the upcoming race game he/she should not make this 25¢ bet. This 25¢ bet allows any player (in the course of the upcoming game) to win 25% (variations possible) of the full carryover progressive jackpot funded solely by the 25¢ bets should they win any two different of the “Bet 3¢” three progressives during the 58 min. time period. They would win 75% (100% should there be no consolation winners) should they win 3 of 3 progressives. This also can easily be adapted onto fixed odds slots essentially by installing an artificial time period and creating a separate pari-mutuel pool to receive the 25¢ bets. Then regular play, within the set time period, determines if a player achieves the set criteria based on winning the offered certain progressive pari-mutuel jackpots of the hybrid fixed odds device (either winning enough regular game jackpots to win two of the three, or three of the three criteria progressives).

Such a progressive game like this could build to $3,000,000 or more, recognizing that the consolations will still recycle money to the players on a regular basis. This game can be used with a second element of this invention to be described below—the changing odds element. Also operators can easily guarantee minimum payouts with little risk of losing money by doing so. This is but one exemplary embodiment that can be derived from the teachings here.

A second unique element of this invention also applies to both pari-mutuel historical racing and fixed odds slot machine wagering. It greatly enhances the attractiveness of progressive jackpots of both pari-mutuel Historical Racing and fixed odds slot wagering.

This element will be called “changing odds.” First, it will be described as it is applied to pari-mutuel Historical Racing. Should a race game end without a progressive jackpot full winner, normally (the current state of the art managing any progressive jackpot offered in Fixed Odds Machines or Historical Racing maintains the odds completely stable through the first bet made into it until the last bet made that wins it) that game would simply replay with the same probabilities and odds until someone would achieve a full win. But using “changing odds” the game operator may substitute a different set of historical odds from a different race. If the operator chooses a set of much higher probabilities/lower odds, then a scenario could occur where virtually all of the players could each win $1000 to $2000 from a carryover that reached $1,000,000 or more when changing odds is applied.

One can see the possibilities of this new tool applied to Historical Racing pari-mutuel and fixed odds slot machines. An operator can distribute a large amount of cash to many players all in a 58 minute period. The economics, excitement, and entertainment value for any operator to be able to apply this to his/her customer base is clear. Enormous demand will develop whenever a large carryover progressive jackpot occurs. This device is fair to all players because prior to changing the odds, any player fortunate enough to win the Progressive might win $1,000,000 instead of, say $1200, after the odds were changed. Historical Racing may draw its probabilities for winning from the closing odds of past races, or the like. It is a simple matter to change odds by selecting a different past race or set of past races (example: a Pick 9).

Second, the application of changing odds to fixed odds slots is simple. Again, merely apply an artificial time period and create a game with a timed wagering period. Next apply for regulatory changes to allow these alterations. If that is achieved, then simply set up the appropriate criteria to win the progressive jackpot, fund the separate pool in a pari-mutuel manner divorced from the regular fixed odds play (as earlier outlined), and use appropriately high odds within the fixed odds jackpot menu to build a high carryover progressive jackpot. Then at an appropriate point with the jackpot having reached a high carryover value, change the odds—switching the old odds out so that the new odds are easy to achieve so that it becomes very easy to win the jackpot. In this manner changing odds is applicable to fixed odds slot games. The operator could decide to pay to the first winner the entire jackpot. Ending the timed period early, but allowing the timed wagering period to complete, is strongly suggested to achieve the desired object of paying out a good amount of money to many players if not all players playing during the period. On occasion it can be helpful to an operator to be able to raise the odds rather than dropping them (to accelerate the buildup of a large progressive jackpot).

An alternative and perhaps better method to apply the changing odds element onto Fixed Odds Slots would be as follows. It should be noted that this alternative methodology will also be applicable to any system of Historical Racing because it employs the pari-mutuel pools and methods that Historical Racing must use to conduct legal pari-mutuel wagering. That wagering, as applied to Fixed Odds Slots (which is not itself pari-mutuel), will be conducted in a continuous manner (unlike the prior method) without interruptions or in-between game periods where all wagering must stop. This method does not require Fixed Odds Slots (Class 2 & 3) to alter current rules and regulations under which they are governed in any way, as the prior method of application does. To surmise the uninterrupted play method: the Historical Racing Devices must wager into pools governed by pari-mutuel rules and regulations and statutes in the various racing jurisdictions.

Changing odds jackpots will be described which work particularly well in this alternative application to fixed odds slots as opposed to the prior, more cumbersome application.

Because Historical Racing uses results that are known, it is very possible to conduct very low probability pari-mutuel pools (with such high odds against) that no one wins over an extended period. (In the cases of a very high odds special progressive that may play as a game within the regular Historical Racing game and regular Historical Racing progressives—they all have distinct pari-mutuel pools dedicated to them. In the cases of the regular progressives that are won by players achieving “criteria wins” within the Historical Racing offered bet categories there is a coordinated time period so all players have an equal chance to win, and the opening and closing of the pari-mutuel pool that holds the prize money defines that time period). In both cases of special and regular progressives within Historical Racing when there are no winners of the pools, there in fact may be multiple times such pools carry over, resulting in the buildup of very large carryover pools. Then the operators of Historical Racing can choose a race or group of races (as the case for what the progressive carryover jackpot dictates) where the probabilities of winning such races are much greater than the previously used probabilities that were used to build the progressive jackpot up. The Historical Racing bettors then face a situation where perhaps expending $50 (5000 1¢ bets) would result in the high likelihood of winning perhaps 5 shares of a jackpot that might total $1,500,000. If 1,000 bettors were contesting a probability of 1/1,001 (odds of 1000-1 against) and each bet $50 (5000 1¢ bets), you might see 1000 people reaping each an average of 5 wins of $300 each or $1500. (Note: these wins might not even require IRS information.)

It is not hard to understand the unique effect such play could have on the gaming industry or, more precisely, the horse racing industry that utilizes Historical Racing. But fixed odds slots as now constructed cannot utilize such a feature as changing odds jackpots. The problem is that rules, laws, and regulations on fixed odds slots prevent this type of play. The above description explains how this could be accomplished, but it necessitates installing a timed period into fixed odds machines. There is another more efficient, less intrusive method that leaves the fixed odds machine alone and does not affect its play in the slightest. This method merely requires rules that allow fixed odds slot operators to be able to operate a pari-mutuel timed wagering pool that opens and closes independent of the continuous play of the fixed odds slot machine it is piggybacked onto. (A variety of installations—add-on server device or integrated feature into the physical case of the fixed odds machine—are possible. The graphics and texts of the display screen on the fixed odds device will be able to inform the bettors on how to play, jackpot size, time period of the game, etc.)

An example of operation: say a fixed odds slot has 5 distinguishable particular fixed odds jackpots available in its regular play format. All the ordinary functions with the usual payouts of these jackpots (and all others of the fixed odds device) remain unchanged. Furthermore, no active interaction takes place between the fixed odds device and the piggybacked pari-mutuel pool installed onto the fixed odds device. The piggybacked pari-mutuel pool merely accumulates bets and reads results that take place on the fixed odds device in the course of the bettor's regular play on the fixed odds device. But the piggybacked separate pari-mutuel pool is set up (in this example—other bet details can vary) to accept a bettor's optional 1¢ bet. These 1¢ bets would accumulate from all the linked fixed odds slot machines in a common pari-mutuel pool. The 1¢ bet would then “qualify” the bettor's “pull” (and only that one pull) on his/her regular play on the fixed odds machine. The now qualified bet would mean that any of the particular 5 example jackpots that were won on the fixed odds regular play would be noted as achieving a criteria toward winning the separately funded (by the 1¢ bets) piggybacked pari-mutuel jackpot. Let's say the overall criteria to win the piggybacked pari-mutuel jackpot would be to win 5 of 5 of the criteria jackpots within the timed period that the pari-mutuel piggybacked progressive plays. Say on the top of each hour the period begins and runs 58 minutes, one or more players winning all 5 of 5 designated jackpots on the fixed odds device within that time frame would win the progressive pari-mutuel jackpot. If a player won 4 of 5 they might win a consolation that the operators (one example) could say would be 25% of the money bet in the 58 minutes (the 1¢ bets only that are deposited to qualify the fixed odds results). Note: regular play is totally unaffected on the fixed odds device and wins and losses incurred there remain there. For ease of betting the 1¢ button might, when depressed, light up and automatically debit 1¢ (deposit it into the separate pari-mutuel pool) on each “pull” of the fixed odds device made for the player's regular betting, thus qualifying all the bettor's regular plays without the bettor having to activate the button each time. Should a bettor press the button it would pop up and become dark and stop deducting 1¢ per pull and then such pulls would not produce qualified bets for the player to win the progressive. One using this system leaves the fixed odds machine completely isolated. Thus no rules, laws, or regulations are needed except to be able to conduct pari-mutuel progressives onto the fixed odds device to simply read the device to determine if criteria have been met in the timed wagering period to win the progressive jackpot. It is the operator's choice as to how large a bet need be made on the fixed odds device to play this game, but as one example the 1¢ bet into the progressive might remain—but operators are free to designate the size of that bet and what the bet would actually consist of as to winning certain fixed odds jackpots offered on the fixed odds slot. This would result in uninterrupted play for the fixed odds device, and 58 minutes of 60 for the piggybacked pari-mutuel progressive.

Many different progressives are possible using the inventive methodology that would prove entertaining to bettors. Now should no one hit this progressive, which depends on winning the 5 designated jackpots in the timed period, perhaps $1,000,000 could be built up. The operator could then allow the original 5 jackpot criteria on the game (note: dissimilar fixed odds games may be linked to offer this game to many players who might prefer different looking games—but all the used criteria jackpots would, while perhaps looking different, be mathematically identical to one another) to be “retired” and use another 5 criteria jackpots that also lie embedded within the fixed odds game. However, these may be very high probability jackpots as compared to the original ones that built the jackpot up. Now the identical type scenario could occur here in a fixed odds device environment that was presented above happening in the Historical Racing device environment. Operators could control cash distribution to the floor players. Of note: this changing odds is always fair because a player gambling before the odds were drastically dropped would, of course, have a much harder time winning the progressive but, if he/she should, his/her jackpot could be, perhaps, $500,000 (2 winners) or $1,000,000 (one winner)—not $1000 or $1500 if he/she won the next day when the odds were drastically lowered.

Such a method could revolutionize the fixed odds slot industry. Player excitement would be enormous should such a methodology be employed. Only minor regulation and rules changes would be required that would add the ability of the Fixed Odds Slots to operate with a piggybacked, passive, timed pari-mutuel progressive pool.

Below is an example of a more complex system from Historical Racing progressives as applied to fixed odds devices with changing odds jackpots. (Note that many, many variations both from Historical Racing and Fixed Odds Devices are possible, but the principle of the invention remains.)

Perhaps a 3¢ progressive multi-bet could be applied to fixed odds devices as follows—the system would again have a qualifying feature bet of 3¢ represented by a button just as described above as the 1¢ bet button. Each player on a fixed odds device could elect to activate the 3¢ bet for each of his/her pulls, thus qualifying his/her bets on the fixed odds device to potentially win the accumulating three 1¢ separate progressives. Or, if the bettor left the button off, they would be ineligible to have qualified winners for the pari-mutuel progressives yet their bets on the fixed odds device would certainly count on that device. Now should the bettor achieve criteria jackpots on the fixed odds device, they would be on their way to possibly winning one or more offered progressive jackpots if they conclude the criteria during the timed lifespan of the piggybacked pari-mutuel pool. A variety of fixed odds jackpot wins would constitute criteria to win on the pari-mutuel side of this hybrid machine. The 3¢ bets would accumulate large sums into the pari-mutuel pools that could (in this example) be split into 3 separate pools to fund each set of different certain criteria set up to win such jackpot based on achieving certain criteria wins on the fixed odds device.

Now an additional game arbitrarily identified as “Sweep 3” (additional varieties may be conceived to follow these principles) could be set up, for say, a single 25¢ bet at the start of any timed piggybacked pari-mutuel progressives. Perhaps the game would run 58 minutes and repeat each hour. This separate 25¢ pool would award to any player or players who might win 3 of the 3 1¢ progressives—consolation winner might be 2 of the 3 progressives. Huge multi-million jackpots could build with this type of game. Importantly, of course, the operators can step in with their best judgment and decide to “change the odds” when they wish to distribute many hundreds of dollars to perhaps thousands—to virtually all the individual players in attendance. Virtually any player at a machine would win significant money when this happens.

Again, fixed odds slots rules, laws, and regulations need not be altered except that operators would need rules to piggyback these time period pari-mutuel bets onto the fixed odds slots. This is an easier task than trying to change rules for Class 2 and Class 3 machines.

Another example for the piggybacked pari-mutuel pool could be a single very high odds jackpot on the fixed odds slot. When a very large jackpot accrues, the operator could shift the qualifying criteria to win this jackpot over to a sister jackpot on the fixed odds slot that has a much higher probability/much lower odds against. This would, of course, allow for the operator to distribute, say, $1,000,000 to 1000 players at $1000 at a time. While the fixed odds device itself would not change, the fixed odds slots operators would need to secure permission to offer the pari-mutuel piggybacked pool and permission to apply changing odds. Changing odds in this case (on the Fixed Odds Device) would most easily be accomplished by switching, within the fixed odds slot, from a very high odds against a jackpot or jackpots to sister jackpot or jackpots residing within the fixed odds game all along, but which have much lower odds against (easier to win).

Again, of note is the fact that even when the jackpot is getting large (say $900,000) and the probability of the criteria needed to win it on the fixed odds machine is still very low (before an operator changes the odds), the lucky player(s) playing and getting lucky to win would not win a mere $1000 but would win $450,000; perhaps even one player winning $900,000. This demonstrates the fairness of the changing odds feature in any environment—Historical Racing or Fixed Odds Slots—and therefore there should not be a fairness argument to defeat such changes to rules and regulations that would allow such.

Following an example of a super progressive jackpot: Play takes place as with the aforementioned “criteria” progressives that “read” the fixed odds device to see if a player has met the criteria to win the progressive—i.e., 5 of 5 winners, etc. But with a super progressive, one could set up a new probability not already in the fixed odds device but within the pari-mutuel piggybacked on the fixed odds device. Along with a random number generator to access the probability of the progressive, now within the piggybacked pari-mutuel pool itself, this super progressive would be timed for perhaps the same 58 minutes, like the criteria progressives, but other than drawing credits from the fixed odds device it would have no need to now even read results from the fixed odds device. As an example, players might be allowed to automate play and dedicate, say $20 at 1¢ bets=2000 bets that would trial on a small screen within the major screen of the fixed odds device, over the 58 minutes. In this manner the player could watch his/her bets play out over a 58 minute period while continuing play on the fixed odds device and even playing criteria pari-mutuel progressives—all three at the same time.

Also, operators may employ changing odds at the appropriate time to enhance the gaming experience.

The super progressive (since virtually all bets lose—unless the odds have been changed) is best played in this “sub rosa” manner so players can watch their regular play that has frequent winners on the fixed odds device.

A third element of this invention will now be illustrated. The third element can utilize part current state of the art and part this new methodology. One of the important reasons fixed odds slots embed a progressive jackpot within its regular game is to prevent many players from having to wager against high odds and nothing else. This would result in virtually all players losing almost all bets (once in a while one or two players would win)—a very boring and discouraging and depressing manner in which to operate a gambling floor. For this third element of the invention, a single pool would be utilized to agree into, with a single very low probability, high odds, against barrier to success. But it would not be embedded with any other bets (adapting it to both pari-mutuel Historical Racing and Fixed odds slot machines.) Instead, this dedicated high odds bet is played in a novel way. The third element is the playing of a super progressive, “sub rosa,” underneath the regular play.

“Twin Pick Six”, as arbitrarily identified, involves funding two very high odds pick sixes. Perhaps 80,000-1 and 110,000-1. The players are given an option to bet from 1¢ to $100 in 1¢ bets at the start of the game. The $100 limit is used to prevent organized syndicates from dominating play when a very large carryover progressive jackpot builds up. The $100 limit allows any good customers the chance to more fairly compete for a large payoff in the event an organized syndicate attempts to dominate play when such a large jackpot (progressive) develops. Should a player, for example, elect to dedicate $10 on the super progressive, the computer would play 1000 1¢ bets over 50 minutes (20 bets per minute). Now a regular game is taking place over this 58 minutes but a small screen would open up within the main screen of the regular game display and show the player his/her progress concerning the super progressive. This psychologically is conducive to betting. It extends the pleasure of the daydream of riches to come and avoids a full quick decision that is virtually always a loss. It also allows for virtually all players to lose virtually all these bets but still not be too discouraged as most of their attention is being taken up by the concurrent regular game with many wins, bonus rounds, and other game events simultaneously taking place. This allows dedication of this single pool to the super progressive and will not elevate effective commissions as fixed odds slots do with their current methodology of mixing the progressive in with a regular game. The problem the fixed odds slots have is that if a player does not win a big jackpot and the game is set at 10% commission, most players face an effective commission of 11 to 11½%. In this method, that is prevented by leaving the regular game alone and having a single probability pool—yet players would not be bored and discouraged by reason of virtually all players losing every bet and having to focus on that. That scenario—losing virtually all bets—occurs but the invention converts the downbeat experience into an extended period to daydream about the big winner that is possible while being entertained by the regular game and its events in front of them while the Twin Pick Six is played sub rosa but still displayed as a secondary image.

Note that the second element—changing odds—works exceptionally well in combination with this element (it works with all the elements of this invention). Additionally, this third element of sub rosa play with a single probability pool can be adapted to fixed odds slots by implementing a separate single probability pari-mutuel pool on top of their regular game and then adding a timed wagering period, without changing the Fixed Odds Slot's play. The Fixed Odds Slots can also implement changing odds onto this element, just as Pari-mutuel Historical Racing does. This allows the game operator to provide nearly all their in attendance players with substantial winnings all at once and at opportune times as the operator sees fit to do, without having a large total jackpot, all the time, being won by a single player which effectively pulls that money off the gambling floor and out of the churn.

For this preferred embodiment (Twin Pick Six) it is suggested to have all the 1¢ bets first trialed against the probability of beating the lower odds pick six and should they win that bet they automatically win a consolation of a full 25% of the entire carryover pool (this differs substantially from consolations that were described earlier as 25% of the net pool bet only on the current game). One does so (understanding many variations are possible) because there is an interest in returning substantial prizes frequently to keep player interest high. After winning the first of the pick sixes, the remaining 1¢ bets will trial against the higher odds pick six in an attempt to win the big jackpot 100% of the carryover or 75% if there are consolation winners in that race game wagering period. Other percentage divisions are, of course, possible. The uniqueness of element three (sub rosa play) is that while the progressive jackpot is within a regular game it is a totally independent game that is played totally separately from the regular game, giving the player the choice on how much to fund that game with his/her bets. This allows him/her to play the regular game without an effectively increased commission should he/she (most likely) not win the progressive bet. In other words, the player is given the choice to decide how much he/she gives up to try for the progressive. In current state of the art, in fixed odds slots, while the progressive is truly embedded in the regular game (to avoid the downer effect of players losing virtually ever play for an extended period) it takes a toll on the players (most all players) who do not win the progressive as a small part of their bet is siphoned off to fund the progressive, causing the effective percentage they bet against to increase. The inventive solution (element three) gives the player a choice on how much they wish to risk playing a single odds progressive. One uses the regular game it is played with to prevent the downer effect of continuous losing and extends the hopeful period at the same time. One can do a similar thing with element one when a separate funding pool is set up but with criteria set within the regular game to win that separate pool. That also does a similar thing for the bettor—they have a choice on how much to fund the progressive jackpot and at the same time the funding of the progressive does not increase the effective commission they face in the regular game.

The above methodology sets forth an improved gambling experience for today's “machine players.” First, an apart pari-mutuel progressive pool is illustrated funded by choice bets of the players and tied to achieving set criteria in a timed period. If the player achieves the criteria in the timed period, they win. The player does not suffer effectively higher commissions should he/she not (and the vast majority of players won't) win a large progressive jackpot, as he/she suffers now when participating in the current state of the art Fixed Odds Slot games featuring progressive jackpots. Many players actually make bets in the current state of the art Fixed Odds Slot machines that are not high enough even to qualify them to win the progressive jackpot, yet they suffer the “tax’ of higher effective commissions by having some of their bet siphoned off to fund and grow the progressive (they unfairly aren't even eligible to win). The inventive improvement applies to both pari-mutuel Historical Racing and current Fixed Odds Slots and adaptations have been outlined herein needed to apply to Fixed Odds Slots.

Second, a concept radically different from current state of the art progressive jackpots played on Fixed Odds Slot machines is introduced: changing odds. This allows operators the opportunity to create great excitement and improve the churn of money back to the players. This improvement applies to pari-mutuel Historical Racing and Fixed Odds Slots with approval to add on a separate pari-mutuel pool but otherwise not change the Fixed Odds devices. The prior described method does internalize some changes to the Fixed Odds devices but works equally well if those changes to Fixed Odds Slot's rules are obtained.

Third, a new methodology is illustrated to use a single or double probability (one or two small winning probabilities, everything else loses—this is far different from the current state of the art progressive jackpots played in Fixed Odds Slots now, where the entire universe of outcomes includes a very small probability of accessing the progressive jackpot and many other probabilities to access smaller prizes and many, many other probabilities that win nothing. This state of the art fixed odds slots method causes a hidden “tax” in the form of higher “effective” commissions placed on the vast majority of players who won't win a progressive jackpot) progressive jackpot pool directly funded by the players and played simultaneous but separately, to a regular game in order to remediate an experience where virtually all the players lose virtually all their bets. The players instead can focus on the regular game which supplies them with many winners and entertaining events to take the focus off the progressive game where nearly all bets lose. Yet because the game runs 58 minutes, the player keeps the hope of winning a progressive alive the entire game time. Anticipation is preserved. The improvement applies to pari-mutuel Historical Racing as well as Fixed Odds Slots.

Note that the second element—changing odds—is applicable universally with any progressive jackpot and, of course, using it with the first and third elements in this invention is a preferred embodiment. In adapting all elements of the invention to Fixed Odds Slots one must introduce an external or internal timed pari-mutuel pool. Specifically, when applying changing odds to fixed odds slots, that would only require some administrative rules changes and permission to conduct a timed pari-mutuel pool (more extensive changes were also described as possible alternative embodiment).

Finally, the invention contemplates adding wagering choices and wagering amount choices for the bettor that are non-existent now in current state of the art Fixed Odds Slot machines and in pari-mutuel Historical Racing. Today, a player is at the mercy of commissions and has few choices on games that lump together regular play and progressive jackpots. Things are separated out so a player can have more choices on what to bet and how much to bet than is currently available. This methodology should prove very popular with today's abused players and allow them to very much more tailor their play to better suit their preferences and at the same time have a more entertaining and anticipation-filled gambling experience, as well as partaking in an experience (changing odds) where, at times, virtually all players at a machine, when changing odds is put in play, may win hundreds or even thousands of dollars.

As shown in FIG. 1, an exemplary form of progressive wagering system is shown at 10. The wagering system 10 is shown in a schematic form to encompass virtually a limitless number of different configurations, and interaction, for each of the components thereof. With the inventive teachings in hand, one skilled in the art would be able to develop many different forms of this system to perform with the added value described above.

More specifically, the wagering system 10 includes at least one processor 12 and a wagering base 14 having information 16 therein. A plurality of terminals 18, 20 are provided at which wagers are directed to the wagering base through inputs 22, 24, respectively. The processed input wagers create a first pool 26.

The wagers are input at the terminals 18, 20 to access the information 16 in the wagering base 14. The probability value for accessing, through input wagers, information 16 in the wagering base 14 is different for different of the information 16 that is in the wagering base 14.

The at least one processor 12 is programmed to: (a) identify wagers that have accessed information 16 in the wagering base 14; and (b) identify a return for each input wager accessing the information 16 in the wagering base 14.

The plurality of terminals 18, 20 are configured to allow selective inputting of at least a part of an input wager to a second pool 28.

The at least one processor 12 is programmed to award a payout to a first player from the second pool 28 based upon criteria related to the first player's activity related to the first pool 26.

The foregoing disclosure of specific embodiments is intended to be illustrative of the broad concepts comprehended by the invention.

1. A progressive wagering system comprising,
at least one processor;
a wagering base having information; and
a plurality of terminals at which wagers are input to create a first pool and to access the information in the wagering base,
a probability value for accessing, through input wagers, information in the wagering base being different for different of the information that is in the wagering base,
the at least one processor programmed to: (a) identify wagers that have accessed information in the wagering base; and (b) identify a return for each input wager accessing the information in the wagering base;
the plurality of terminals configured to allow selective inputting of at least a part of an input wager to a second pool,
the at least one processor programmed to award a payout to a first player from the second pool based upon criteria related to the first player's activity related to the first pool.
